(19) United States
(12) Patent Application Publication
(10) Pub. No.: US 2015/0237465 A1
(43) Pub. Date: Aug. 20, 2015

(54) METHOD AND APPARATUS TO SWITCH BETWEEN NETWORK-BASED AND MOBILE-BASED POSITIONING MODES

(71) Applicant: QUALCOMM Incorporated, San Diego, CA (US)

(72) Inventors: Ferit Ozan AKGUL, Santa Clara, CA (US); Ramya Srinivasan, Campbell, CA (US); Gaurav Lamba, Los Altos, CA (US)

(73) Assignee: QUALCOMM Incorporated, San Diego, CA (US)

(21) Appl. No.: 14/184,502

(22) Filed: Feb. 19, 2014

(51) Int. Cl. H04W 4/02

(52) U.S. Cl. CPC H04W 4/02

(57) ABSTRACT

Systems, methods and apparatus for using positioning modes including mobile-based and network-based positioning modes are presented. The mobile device comprises a transceiver configured to receive an individualized command from a server instructing the mobile device to switch from the first positioning mode to the second positioning mode. The individualized command is based on at least one of: (1) a determined accuracy of the mobile device; (2) a state of a resource; (3) a comparison between a network load and a threshold; (4) a geo-fence; or (5) a combination thereof. The mobile device also comprises a processor coupled to the transceiver, wherein the processor is configured to: operate in the first positioning mode before receiving the individualized command; switch from the first positioning mode to the second positioning mode based on the individualized command from the server; and operate in the second positioning mode after receiving the individualized command.

### BACKGROUND

I. Field of the Invention

This disclosure relates generally to systems, methods and apparatus for wireless position determination, and more particularly to switching between a mobile-based positioning mode for position determination and a network-based positioning mode for position determination.

II. Background

Terrestrial or indoor positioning systems may be characterized either as a mobile-based positioning (MBP) system (using a mobile device to determine a position) or as a network-based positioning (NBP) system (using both a mobile device and a server to determine a position). These systems are similar to GNSS based systems having MS-based or MS-assisted modes in location determination. Each architecture has its own advantages and disadvantages. It is possible to deploy either system systems at a particular venue at a certain time. Currently, an intelligent and individual mobile switching mechanism to switch between these system types is not available. What is needed is an individual mobile device that can perform either mobile-based or network-based positioning depending on current mobile or network conditions.

### BRIEF SUMMARY

Disclosed are systems, methods and apparatus for using positioning modes.

According to some aspects, disclosed is a mobile device comprising: a transceiver configured to receive an individualized command from a server to switch from a first positioning mode to a second positioning mode, wherein the first positioning mode is different from the second positioning mode; and a processor coupled to the transceiver, wherein the processor is configured to: operate in the first positioning mode before receiving the individualized command; switch from the first positioning mode to the second positioning mode based on the individualized command from the server, wherein the individualized command is based on at least one of: a determined accuracy of the mobile device; a state of a resource; a comparison between a network load and a threshold; a geo-fence; or a combination thereof; and operate in the second positioning mode after receiving the individualized command.

According to some aspects, disclosed is a method in a mobile device, the method comprising: operating in a first positioning mode; receiving an individualized command from a server to switch from the first positioning mode to a second positioning mode, wherein the first positioning mode is different from the second positioning mode, and wherein the individualized command is based on at least one of: a determined accuracy of the mobile device; a state of a resource; a comparison between a network load and a threshold; and a geo-fence; or a combination thereof; and switching from the first positioning mode to the second positioning mode based on the individualized command from the server; and operating in the second positioning mode after receiving the individualized command.

According to some aspects, disclosed is an apparatus comprising: means for operating in a first positioning mode; means for receiving an individualized command from a server to switch from the first positioning mode to a second positioning mode, wherein the first positioning mode is different from the second positioning mode, and wherein the individualized command is based on at least one of: a determined accuracy of a mobile device; a state of a resource; a comparison between a network load and a threshold; and a geo-fence; or a combination thereof; and means for switching from the first positioning mode to the second positioning mode based on the individualized command from the server; and means for operating in the second positioning mode after receiving the individualized command. It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIGS. 1 and 2 illustrate switching between a network-based positioning mode and a mobile-based positioning mode, in accordance with some embodiments.

FIGS. 3-10 illustrate requesting one of a mobile-based positioning mode and a network-based positioning mode, in accordance with some embodiments.

FIGS. 11 and 12 show methods in a mobile device and a server for switching from a network-based positioning mode to a mobile-based positioning mode, in accordance with some embodiments.

FIGS. 13 and 14 show methods in a mobile device and a server for switching from a mobile-based positioning mode to a network-based positioning mode, in accordance with some embodiments.

FIGS. 15 and 16 show a mobile device and a server, respectively, in accordance with some embodiments.

FIG. 17 illustrates a method in a mobile device operating in a first positioning mode and a second positioning mode, in accordance with some embodiments.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as Cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2002 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their position (also referred to as location) on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device 10, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

Systems, apparatus and methods for navigating using navigation detection modes including mobile-based and network-based positioning modes are presented. When both network-based and mobile-based position determination systems are deployed for a specific venue, switching between these two architectures may be needed for various reasons (e.g., network load, an accuracy requirement, processor load, battery load, application load or a geo-fence restriction). For example, a WiFi network experiencing heavy traffic may gradually instruct some or all mobile devices (clients) to switch from a network-based positioning mode to a mobile-based positioning mode for positioning until the heavy traffic is alleviated. Similarly, a WiFi network having excess capacity and experiencing very low traffic may gradually instruct some or all mobile devices (clients) to switch from a mobile-based positioning mode to a network-based positioning mode while traffic is light.

Some mobile devices may require a high level of accuracy while other mobile devices only require a low level of accuracy. Due to the variety of technologies used for positioning (e.g., RSSI and RTT-based positioning techniques), each architecture may have a different positioning accuracy. For instance, if an application of a mobile device 10 requires more accuracy, it may request permission from the server 20 to switch between a mobile-based positioning mode and a network-based positioning mode for positioning assuming the network-based positioning mode provides more accuracy.

A mobile device may require reserving a resource (e.g., CPU cycles or battery power) for later use. If a mobile-based positioning mode is normally used, the mobile device 10 may request that the server 20 performs the position determination instead, if the network-based position is better suited.

A geo-fence may be a factor. For example, specific areas inside a venue require a certain positioning architecture. For instance, for security reasons in a military complex, a client may not be allowed to use an accurate mobile-based positioning. Instead, the mobile device is only tracked by the network but its position is not reported to the mobile device. Cells having a coverage area covering a restricted area may instruct mobile devices 10 to use network-based positioning, while mobile devices 10 outside of the restricted area may use mobile-based positioning. As a result, assistance data is only available when not in a restricted area.

In a network-based positioning mode (also referred to as a network-based position determination mode), one or more network entities, such as a server 20 assisted by a number of base stations determine a position of a mobile device 10. The mobile device 10 may be uninformed, informed or instigate the position determination, and active or passive with the base stations and server 20 in helping to determine its position. In a mobile-based positioning mode (also referred to as a mobile-device position determination mode, a mobile-based mode, a mobile device-based mode or a mobile mode), a mobile device determines its own position with or without the assistance of network elements such as a server 20 and/or base stations. Presently, a procedure that is initiated by the network or the mobile device 10 does not exist to toggle between a mobile-based mode and a network-based mode. New procedures to adaptively toggle or switch between these modes, either conditionally or unconditionally, are explained below. Though a mode may sometimes be referred to as an indoor mode, mobile devices 10 may be physically inside (indoors) or outside (outdoors). That is, some embodiments may operate in either indoors or outdoors.

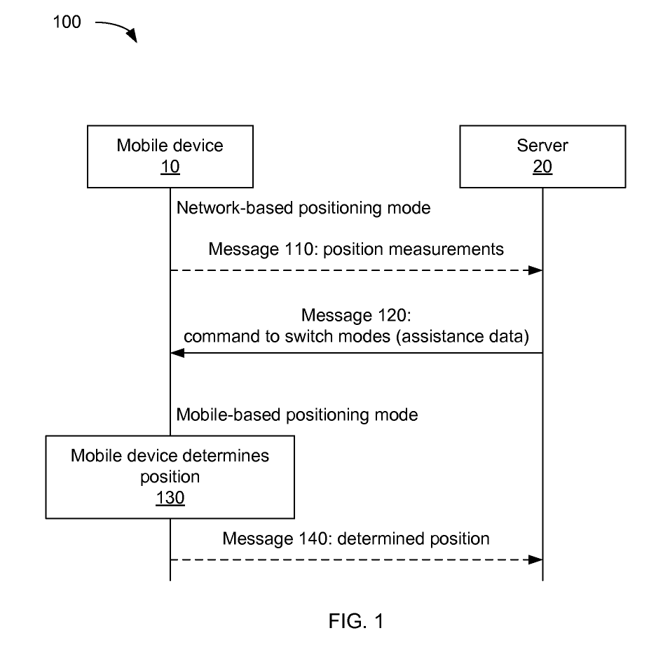

FIGS. 1 through 8 show message communication between a mobile device 10 and a server 20. The message communication between the mobile device 10 and the server 20 indicates a direction of information flow and whether a particular message may be optional (illustrated with a dotted line) depending on a particular implementation. One or more squares shown along a thread of the mobile device 10 or the server 20 indicate a corresponding processing element of that mobile device 10 or server 20. Again, when that process element is drawn with a dotted line, the process element may be optional.

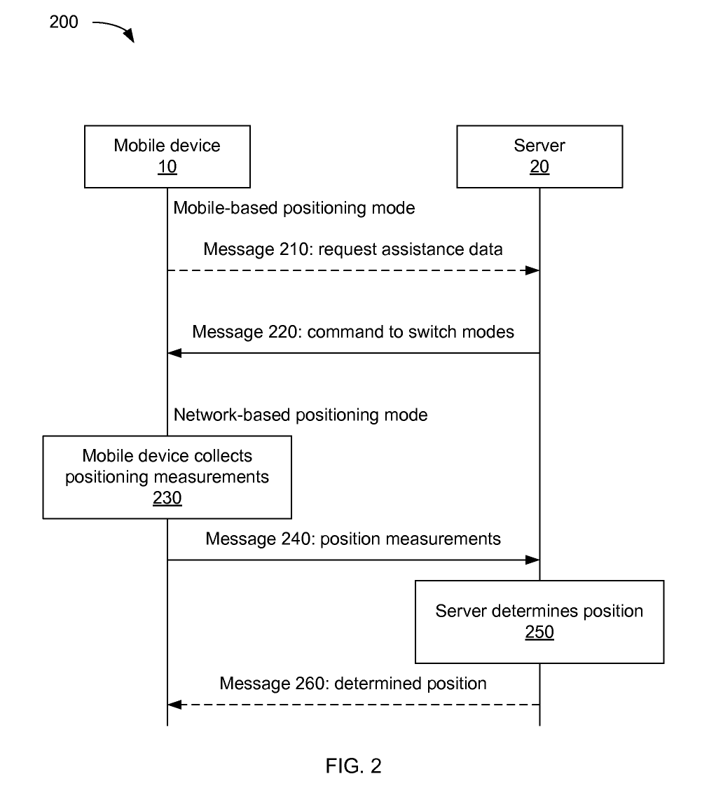

FIGS. 1 and 2 illustrate switching between a network-based positioning mode and a mobile-based positioning mode, in accordance with some embodiments.

In FIG. 1, a mobile device 10 switches from a network-based positioning mode to a mobile-based positioning mode according to thread diagram 100. In this example, the mobile device 10 begins in a network-based positioning mode. In message 110, the mobile device 10 may optionally send position measurements from the mobile device 10 to the server 20.

The server 20 may determine whether the mobile device 10 may handle the position determination better than the network. Alternatively, the server 20 may determine the server 20 has insufficient resources to handle the position determination. Alternatively, the server 20 may determine the mobile device 10 has less uncertainty than the server 20.

For example, either an element of the network (e.g., a base station, a controller and/or the server 20) or an interface between elements (e.g., the air interface between the mobile device 10 and a base station, or an interface between a base station and the server 20) may not have sufficient free capacity or bandwidth to determine or communicate a position of the mobile device 10. Alternatively, the server 20 may determine that an element of the network has less capacity than the mobile device 10 to determine a position of the mobile device 10. This determination may be based on: (1) receiving message 110; (2) a measure of network processing; (3) a measure of interface capacity; and/or (4) a comparison between processing on the mobile device 10 and the server 20.

With message 120 from the server 20 to the mobile device 10, the server 20 commands the mobile device 10 to switch modes from a network-based positioning mode to a mobile-based positioning mode to determine the position of the mobile device 10. Message 120 is directed to a specific mobile device 10 and not sent to all mobile devices. For example, the message 120 is not broadcasted to switch all mobile devices in the entire network over from one mode to another. Message 110 is a point-to-point message or a point-to-multipoint message that instructs an individual mobile device 10 or a subset of mobile devices 10 to switch modes while other mobile devices do not switch away from their current mode. Message 120 may be carried within or sequentially with an assistance data message. If not already in a mobile-based positioning mode, the mobile device 10 then switches from a network-based positioning mode (or other mode) to a mobile-based positioning mode. At 130, the mobile device 10 then determines its position using a mobile-based positioning mode. Optionally, the mobile device 10 may report the position determined at 130 in message 140.

In FIG. 2, a mobile device 10 is in a mobile-based positioning mode according to thread diagram 200. Optionally, the mobile device 10 sends message 210 to a server 20 requesting assistance data from a server 20. Similarly as described above, the server 20 may determine that the network should handle the position determination rather that the mobile device 10. In message 220, the server 20 sends a command to switch modes to a network-based positioning mode the mobile device 10.

At 230, the mobile device 10 collects positioning measurements. For example, the mobile device 10 measures round-trip time (RTT) or a received signal strength indication (RSSI) from one or more access points.

The mobile device 10 reports the positioning measurements just collected in message 240 sent from the mobile device 10 and received by the server 20. At 250, the server 20 determines a position of the mobile device 10 from the positioning measurements. The server 20 optionally reports the determine position to the mobile device 10 in message 260.

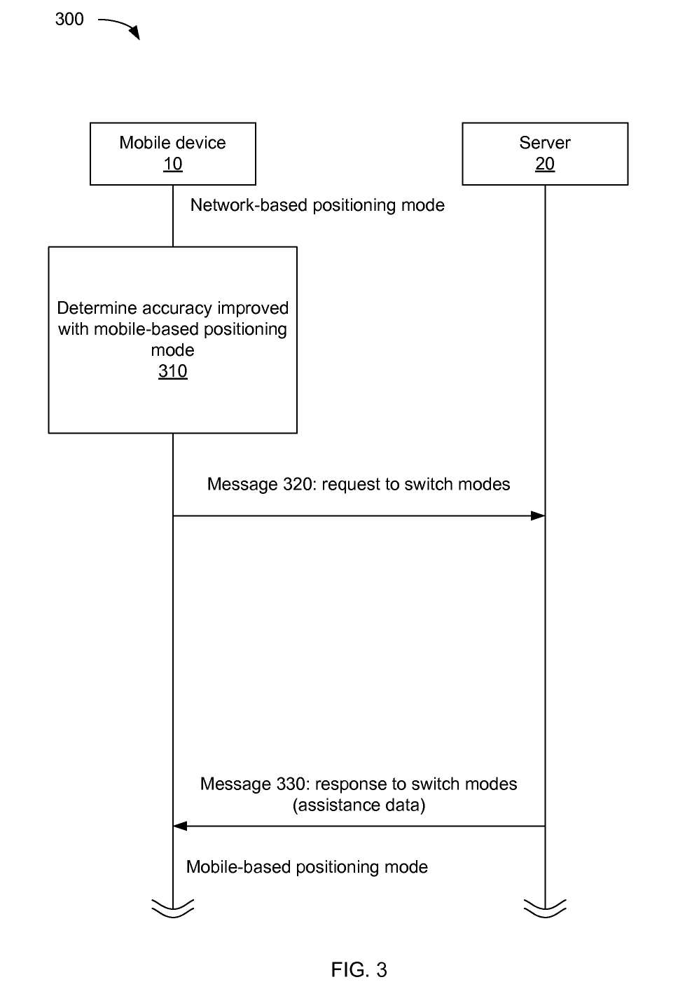

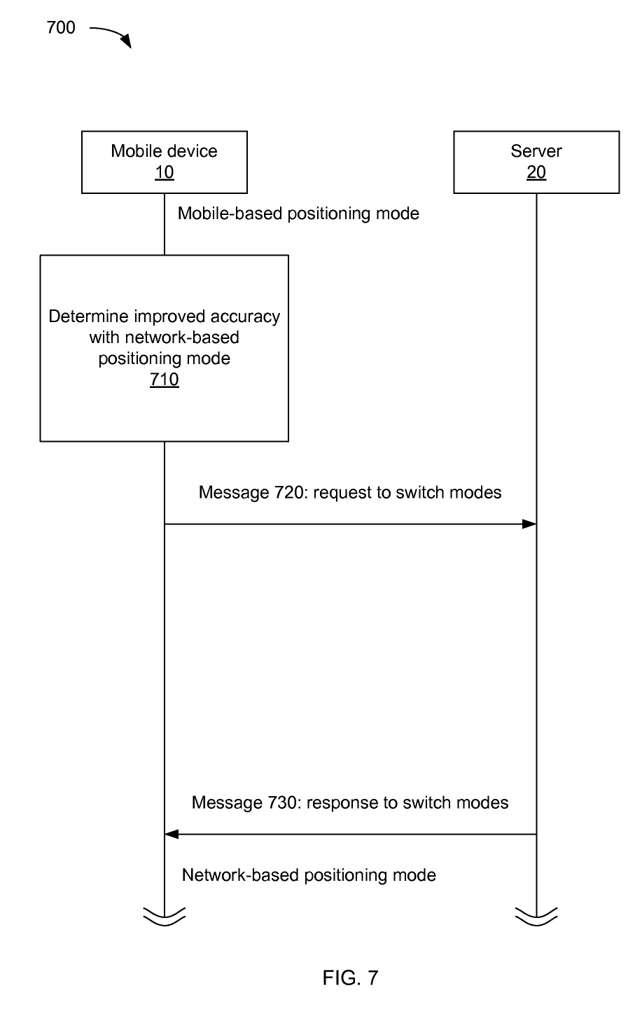

FIGS. 3-10 illustrate requesting one of a mobile-based positioning mode and a network-based positioning mode, in accordance with some embodiments. In FIGS. 3-6, a mobile device 10 switches from a network-based positioning mode to a mobile-based positioning mode. In FIGS. 7-10, a mobile device 10 switches from a mobile-based positioning mode to a network-based positioning mode.

In FIG. 3, a mobile device 10 determines accuracy is improved or a better accuracy is obtained from switching from a network-based positioning mode to a mobile-based positioning mode according to thread diagram 300. At 310, the mobile device 10 determines an improved or a better accuracy may result if a mobile-based positioning mode is used rather than a network-based positioning mode. For example, an uncertainty of the mobile-based positioning mode is less than an uncertainty of the network-based positioning mode. The mobile device 10 sends message 320 to request to switch from the network-based positioning mode to a mobile-based positioning mode. In response, the server 20 sends back response message 330 to switch from the network-based positioning mode to a mobile-based positioning mode. The mobile device 10 then determines its position.

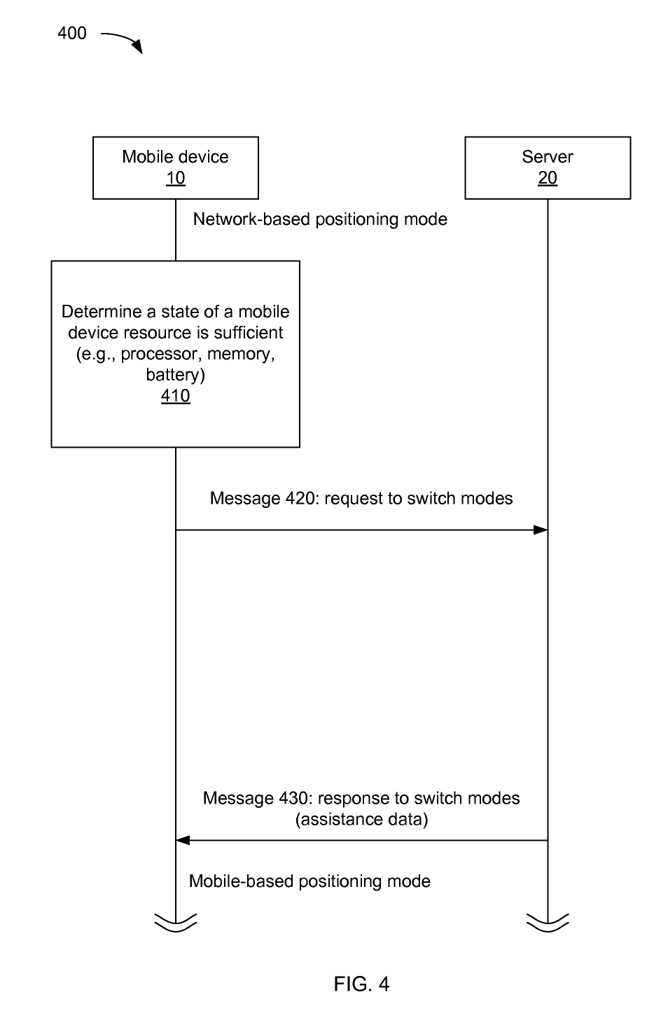

In FIG. 4, a mobile device 10 determines a state of a resource. The state may be an improved or a better mode between a network-based positioning mode and a mobile-based positioning mode according to thread diagram 400. At 410, the mobile device 10 determines that a state of the mobile device 10 is sufficient (e.g., the processor has idle CPU cycles, enough memory is free and/or the battery level is above a threshold). The mobile device 10 sends message 420 to request to switch from the network-based positioning mode to a mobile-based positioning mode. In response, the server 20 sends back response message 430 to switch from the network-based positioning mode to a mobile-based positioning mode. The mobile device 10 then determines its position.

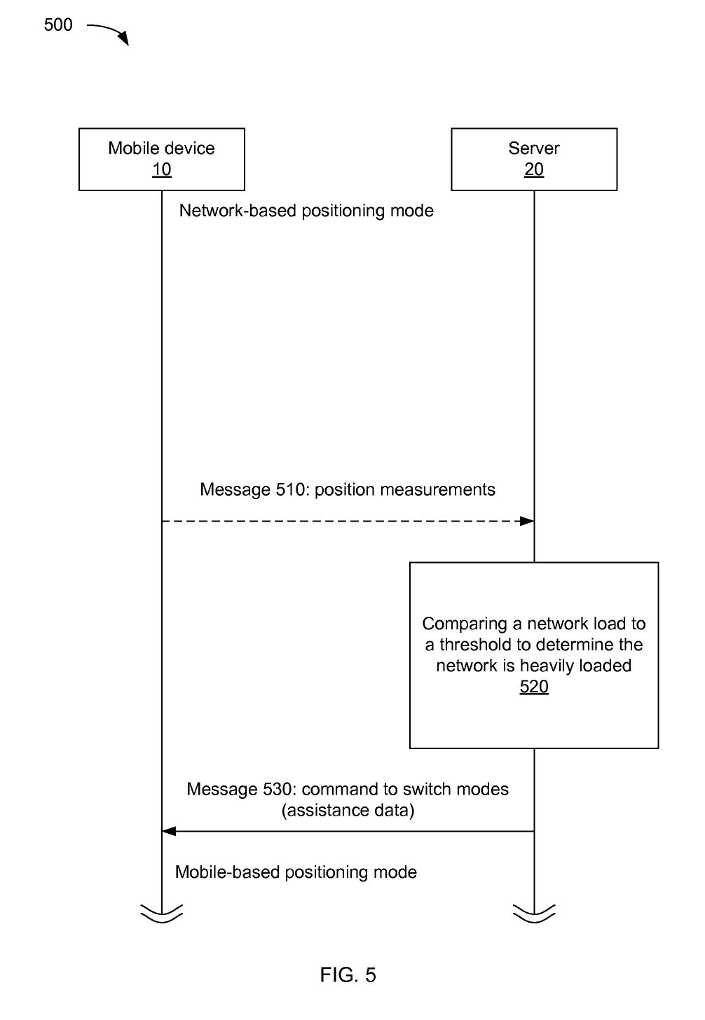

In FIG. 5, a mobile device 10 is in a network-based positioning mode when it needs to determine its position according to thread diagram 500. The network compares a network load to a threshold. In message 510, the mobile device 10 the mobile device 10 begins sending position measurements to the server 20. Optionally, the server may unilaterally decide a mobile-based positioning mode is better than the current network-based positioning mode. At 520, the server 20 compares the network load to a threshold to determine if the network is too heavily loaded. For example, the server 20 may check an indication of network load on the serving base station or one of the elements located after the serving base station. Rather than checking an element load, the server 20 may check an interface load. Alternative, the server 20 may compare a network load or an interface load to a load on the mobile device 10. If the server 20 determines it load is below a threshold or less than a load on the mobile device 10, the server 20 may enter a mobile-based positioning mode. In message 530, the server 20 may instruct the mobile device 10 to switch modes to the mobile-based positioning mode. The message 520 may also include assistance data. The process may continue as shown in FIG. 1 at 130.

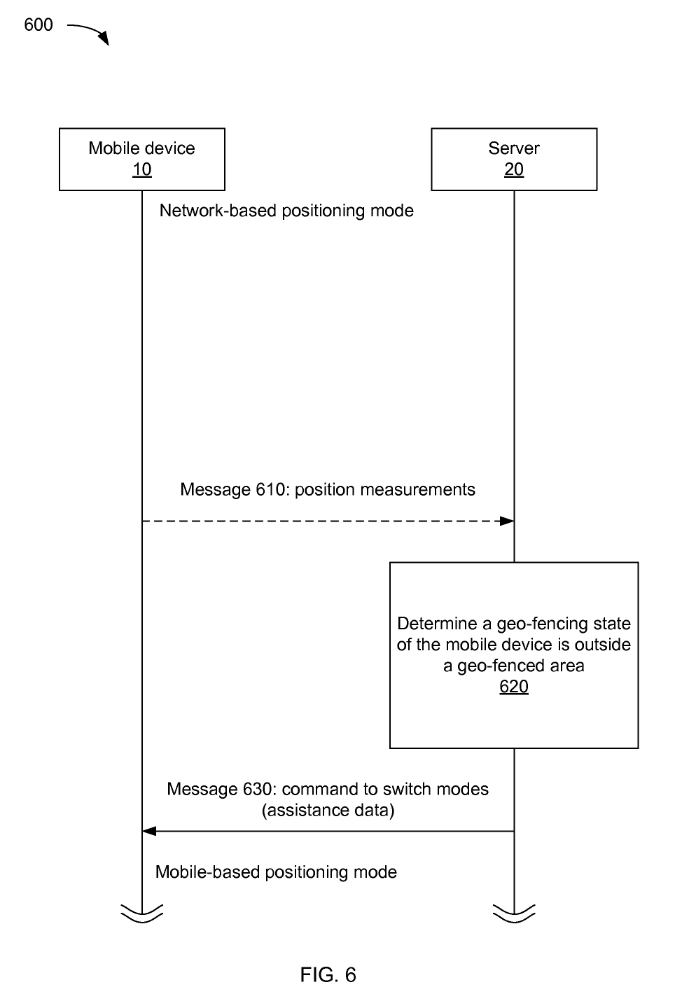

In FIG. 6, a mobile device 10 is in a network-based positioning mode when it needs to determine its position according to thread diagram 600. Here, the mobile device 10 enters, exits or crosses a geo-fence area or boundary. In message 610, the mobile device 10 begins sending position measurements to the server 20. Optionally, the server may unilaterally decide a mobile-based positioning mode is better than the current network-based positioning mode. At 620, the server 20 may force the mobile device 10 to determine its own location in a mobile-based positioning mode. For example, in 620, the server 20 determines a geo-fencing state of the mobile device 10 (e.g., either inside or outside the geo-fenced area or crossing a geo-fence boundary). Depending on the geo-fencing state, the server 20 may set the position to a mobile-based positioning mode or a network-based positioning mode. If the server 20 determines a geo-fence has been entered or exited, the server 20 may enter a mobile-based positioning mode. In message 630, the server 20 may instruct the mobile device 10 to switch modes from the network-based positioning mode to the mobile-based positioning mode. The process may continue as shown in FIG. 1 at 130.

In FIG. 7, a mobile device 10 determines a network-based positioning mode is an improved or a better mode than a mobile-based positioning mode according to thread diagram 700. Here, the mobile device 10 crosses a geo-fence boundary. At 710, the mobile device 10 determines an improved or a better accuracy may result if a network-based positioning mode is used rather than a mobile-based positioning mode. For example, an uncertainty of the mobile-based positioning mode is greater than an uncertainty of the network-based positioning mode. The mobile device 10 sends message 720 requesting to switch from the mobile-based positioning mode to the network-based positioning mode. In response, the server 20 may send message 730 to switch modes. The process may continue as shown in FIG. 2 at 230.

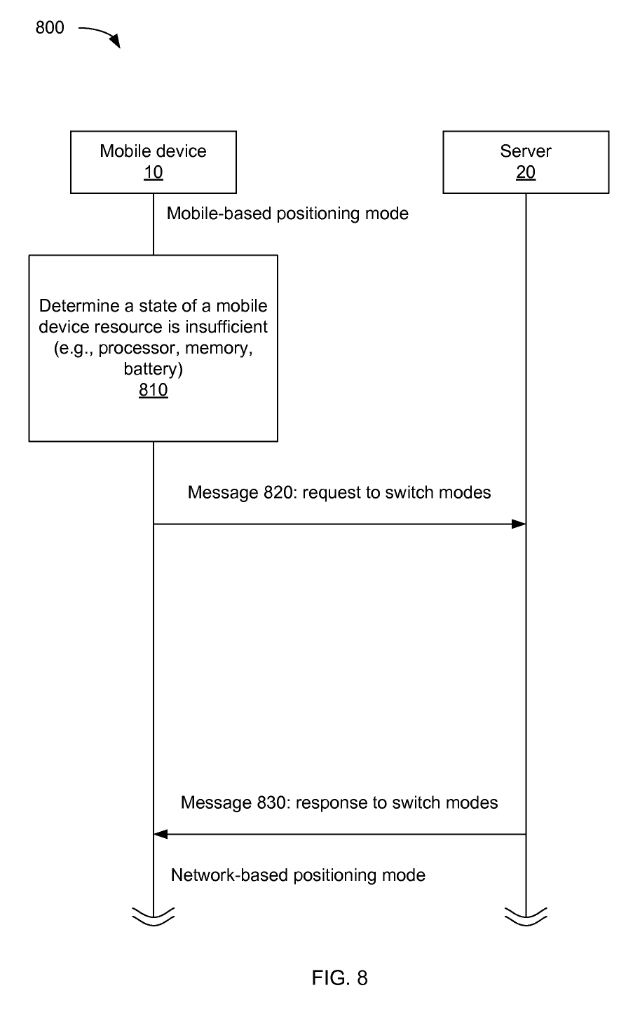

In FIG. 8, a mobile device 10 determines a network-based positioning mode is an improved or a better mode than a mobile-based positioning mode according to thread diagram 800. At 810, the mobile device 10 determines that a state of the mobile device 10 is insufficient (e.g., the processor has inadequate idle CPU cycles, not enough free memory or a battery level is below a threshold). The mobile device 10 sends message 820 requesting to switch from the mobile-based positioning mode to the network-based positioning mode. In response, the server 20 may send message 830 to switch modes. The process may continue as shown in FIG. 2 at 230.

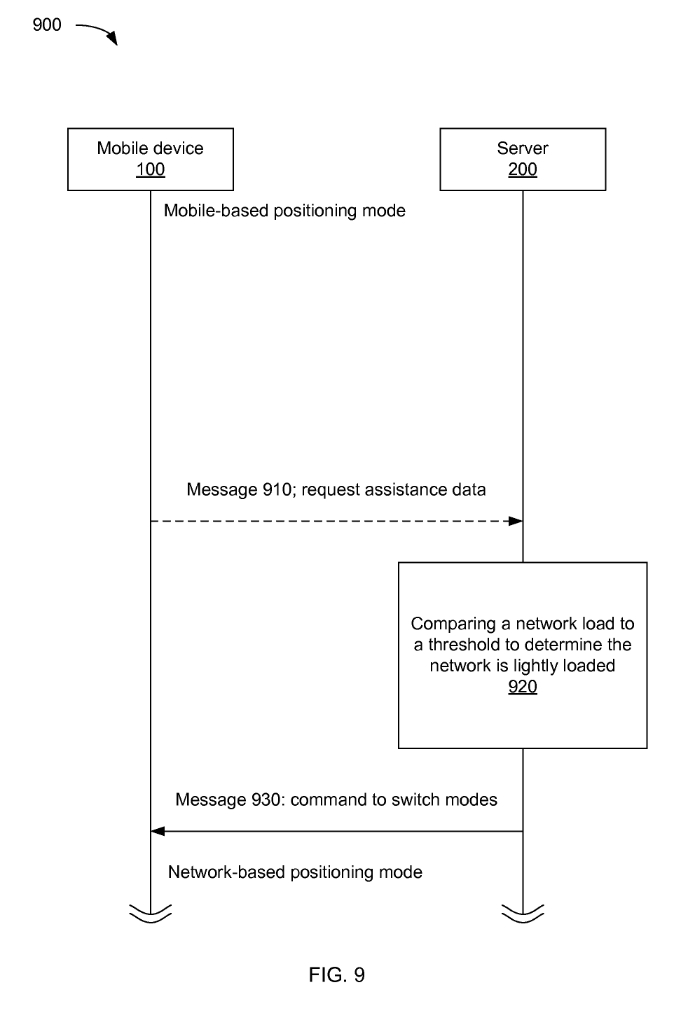

In FIG. 9, a mobile device 10 is in a mobile-based positioning mode when it needs to determine its position according to thread diagram 900. The mobile device 10 sends message 910 to request assistance data from a server 20. Optionally, the server may unilaterally decide a network-based positioning mode is better than the current mobile-based positioning mode. At 920, the server 20 may compare the network load to a threshold to determine if the network is lightly loaded. For example, the server 20 may check an indication of network load on the serving base station or one of the elements located after the serving base station. Alternatively or additionally, the server 20 may check an indication of an interface load. Alternatively, the server 20 may compare a network load or an interface load to a load on the mobile device 10. The server 20 may command the mobile device 10 in message 930 to switch modes to the network-based positioning mode. The process may continue as shown in FIG. 2 at 230.

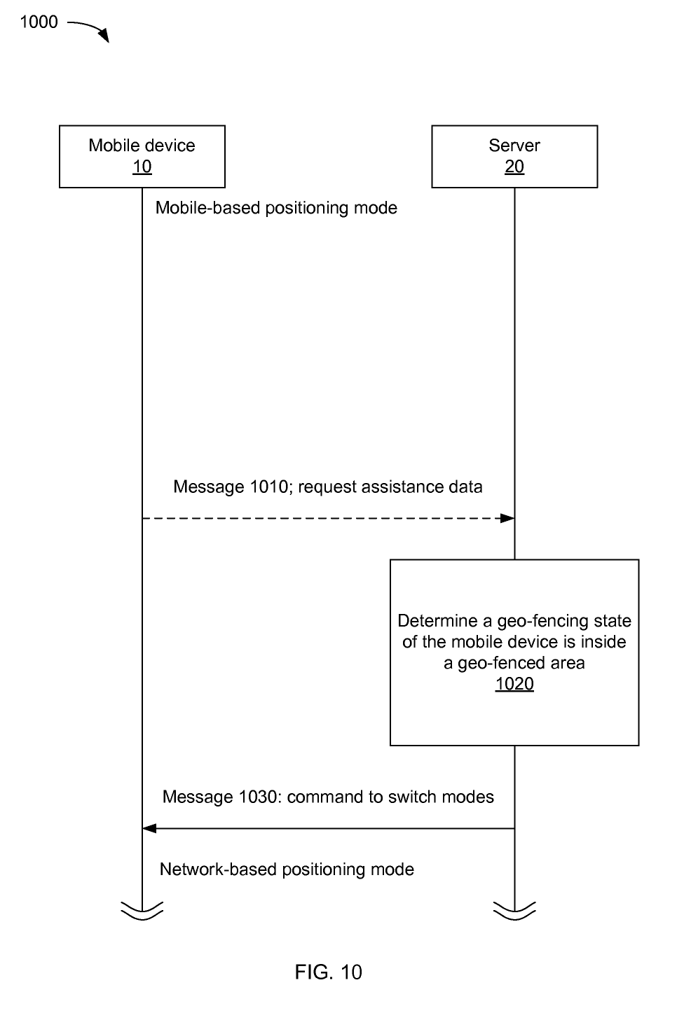

In FIG. 10, a mobile device 10 is in a mobile-based positioning mode when it needs to determine its position according to thread diagram 1000. The mobile device 10 sends message 1010 to request assistance data from a server 20. Optionally, the server may unilaterally decide a network-based positioning mode is better than the current mobile-based positioning mode. At 1020, the server 20 may force the mobile device 10 to determine its own location in a mobile-based positioning mode or may force the mobile device 10 to accept a network determined position in a network-based positioning mode. That is, in 1020, the server 20 determines a geo-fencing state of the mobile device 10 (either inside or outside the geo-fenced area or crossing a geo-fence line). Depending on the geo-fencing state, the server 20 may send message 1030 to change modes from the mobile-based positioning mode to a network-based positioning mode. The process may continue as shown in FIG. 2 at 230.

Some embodiment included just one of 310, 410, 520, 620, 710, 810, 920, and 1020, for example, an embodiment includes just 310 and not 410, 520, 620, 710, 810, 920, and 1020. Other embodiments include two or more of these features. Alternatively, an embodiment may include each of these features.

In some embodiments, conflicting modes may be determined (e.g., a mobile device 10 favor a network-based positioning mode and a server 20 default to a mobile-based positioning mode. In some embodiments, when a conflict occurs, a mobile-based positioning mode is selected. In other embodiments, when a conflict occurs, a network-based positioning mode is selected. In yet other embodiments, when a conflict occurs, a server selected mode is selected. In other embodiments, when a conflict occurs, a mobile device selected mode is selected. In still other embodiments, when a conflict occurs, a status quo is selected. In other embodiments, when a conflict occurs, an opposite of a status quo is selected.

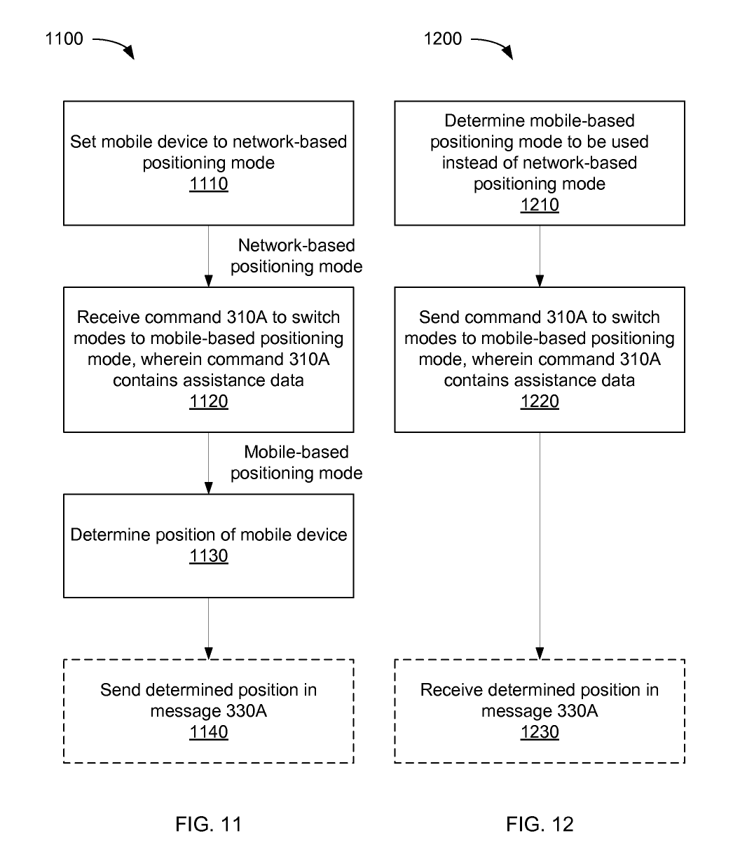

FIGS. 11 and 12 show methods 1100 and 1200 in a mobile device 10 and a server 20 for switching from a network-based positioning mode to a mobile-based positioning mode, in accordance with some embodiments.

In FIG. 11, a mobile device 10 switches to a mobile-based positioning mode based on a message from a server 20 according to method 1100. At 1110, a mobile device 10 sets a mode to a network-based positioning mode. The network-based positioning mode may be a default mode or earlier set by the network as the current mode (e.g., from a server 20). At 1120, the mobile device 10 receives a message (e.g., message 120 in FIG. 1) from a server 20 to switch modes from a network-based positioning mode to a mobile-based positioning mode. The message may contain assistance data, which the mobile device 10 uses to determine a position. At 1130, the mobile device 10 determines its position using the assistance data. Optionally at 1140, the mobile device 10 sends the determined position to the server 20 (e.g., in message 140 of FIG. 1).

In FIG. 12, a server 20 switches a mobile device 10 to a mobile-based positioning mode according to method 1200. At 1210, a server 20 determines to use a mobile-based positioning mode instead of a network-based positioning mode. For example, the mobile device 10 determines an improved or a better accuracy may result if a mobile-based positioning mode is used rather than a network-based positioning mode (e.g., as shown in 520 of FIG. 5 or 620 of FIG. 6). Alternatively, the mobile device 10 determines that a state of the mobile device 10 is sufficient (as shown in 410 of FIG. 4). In either case, the request may be communicated from the mobile device 10 to the server 20 (e.g., in message 320 of FIG. 3 or in message 420 of FIG. 4). Alternatively, the server 20 may compare the network load to a threshold to determine if the network is too heavily loaded (as shown in 520 of FIG. 5). Alternatively, the server 20 determines a geo-fencing state of the mobile device 10 (as shown in 620 of FIG. 6).

At 1220, the server 20 sends a message (e.g., message 120 of FIG. 1) to the mobile device 10 to switch modes from a network-based positioning mode to a mobile-based positioning mode. Optionally at 1230, the server 20 receives the determined position from the mobile device 10 (e.g., in message 140 of FIG. 1).

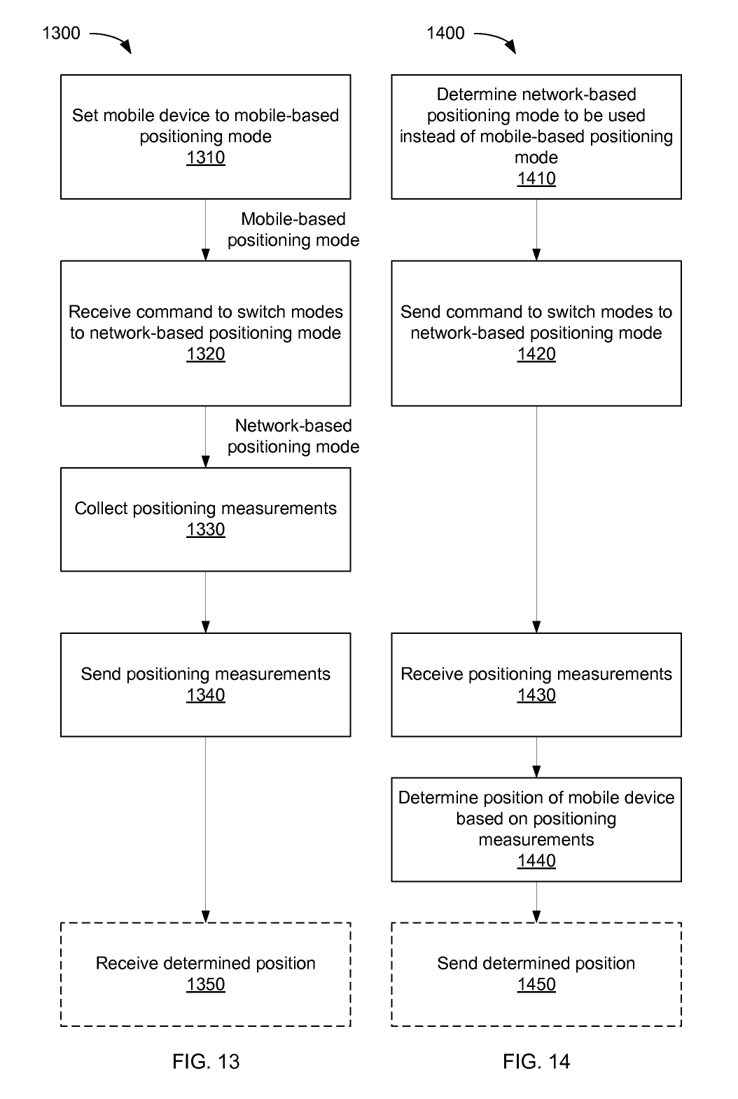

FIGS. 13 and 14 show methods in a mobile device 10 and a server 20 for switching from a mobile-based positioning mode to a network-based positioning mode, in accordance with some embodiments.

In FIG. 13, a mobile device 10 switches from a mobile-based positioning mode to a network-based positioning mode based on a message from a server 20 in order to determine its own position according to method 1300. At 1310, a mobile device 10 sets a mode to a mobile-based positioning mode. The mobile-based positioning mode may be a default mode or earlier set by the network as the current mode in a communication, e.g., from a server 20. At 1320, the mobile device 10 receives a message from a server 20 to switch modes from a mobile-based positioning mode to a network-based positioning mode. This message does not contain assistance data. At 1330, the mobile device 10 collects positioning measurements. At 1340, the mobile device 10 sends the positioning measurements to the server 20. Optionally at 1350, the mobile device 10 receives the determined position from the server 20.

In FIG. 14, a server 20 switches a mobile device 10 to a network-based positioning mode from a mobile-based positioning mode in order for the mobile device 10 to assist in determining its position according to method 1400. At 1410, a server 20 determines to use a mobile-based positioning mode instead of a network-based positioning mode. For example, the mobile device 10 determines the mobile device 10 can better determine the position of the mobile device 10 (as shown in FIG. 3) or the mobile device 10 determines that a state of the mobile device 10 is insufficient (as shown in FIG. 4). In either case, the request may be communicated from the mobile device 10 to the server 20. Alternatively, the server 20 determines its load is below a threshold or less than a load on the mobile device 10 (as shown in FIG. 5) or the server 20 determines a geo-fencing state of the mobile device 10 (as shown in FIG. 6).

At 1420, the server 20 sends a message to the mobile device 10 to switch modes from a mobile-based positioning mode to a network-based positioning mode. The server 20 does not fill this message with assistance data. At 1430, the server 20 receives the positioning measurements from the mobile device 10. At 1440, the server 20 determines a position of the mobile device 10 based on the positioning measurements. Optionally at 1450, the server 20 sends the determined position to the mobile device 10.

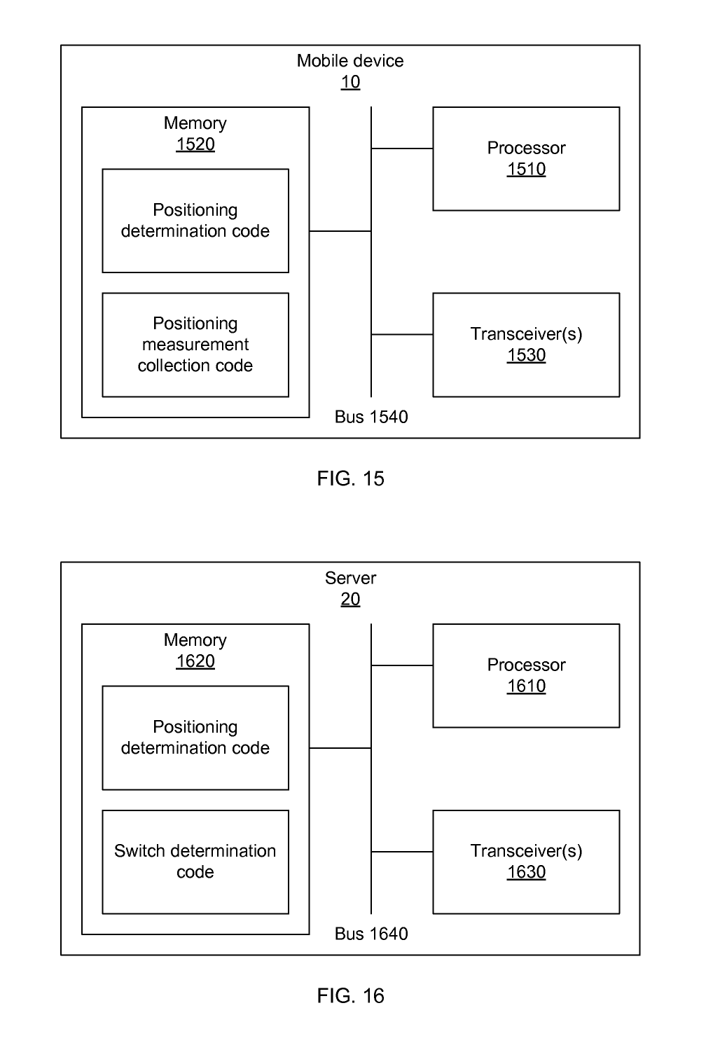

FIGS. 15 and 16 show a mobile device 10 and a server 20, respectively, in accordance with some embodiments. In FIG. 15, a mobile device 10 contains a processor 1510, memory 1520 and one or more transceivers 1530 connected by a bus 1540. The processor 1510 executes methods described herein as being performed by a mobile device 10. The memory 1520 holds program code to perform these methods. For example, the memory 1520 contains code determine a position and collect positioning measurements, which act as means for determining a position and measuring or collecting information for a position, respectively. The information collected may be, for example, round-trip time (RTT) or a received signal strength indicator (RSSI). The code is used to determine a position of the mobile device 10. The code is also used to collect positioning measurements to be sent to a server 20.

The transceiver 1530 includes a receiver and a transmitter and is coupled to the processor 1510, for example with bus 1540. The receiver is configured to receive a command from a server 20 sent to the mobile device 10 to switch from a current mode to an opposite mode. The current mode may be a network-based positioning mode and the opposite mode may be a mobile-based positioning mode. Alternatively, the current mode may be a mobile-based positioning mode and the opposite mode may be a network-based positioning mode. The transmitter is configured to send positioning measurements to the server 20.

In FIG. 16, a server 20 contains a processor 1610, memory 1620 and one or more transceivers 1630 connected by a bus 1640. The processor 1610 performs methods described herein as being performed by a server 20. The memory 1620 holds program code to perform these methods. For example, the memory 1620 contains code to determine a position of the mobile device 10 and code to determine when to switch a mobile device 10. The transceiver 1630 includes a receiver and a transmitter and is coupled to the processor 1610, for example with bus 1640. The receiver is configured to receive a request from a mobile device 10 sent to the server 20 requesting to switch from a current mode to an opposite mode. The transmitter is configured to send a determine position and assistance to the mobile device 10.

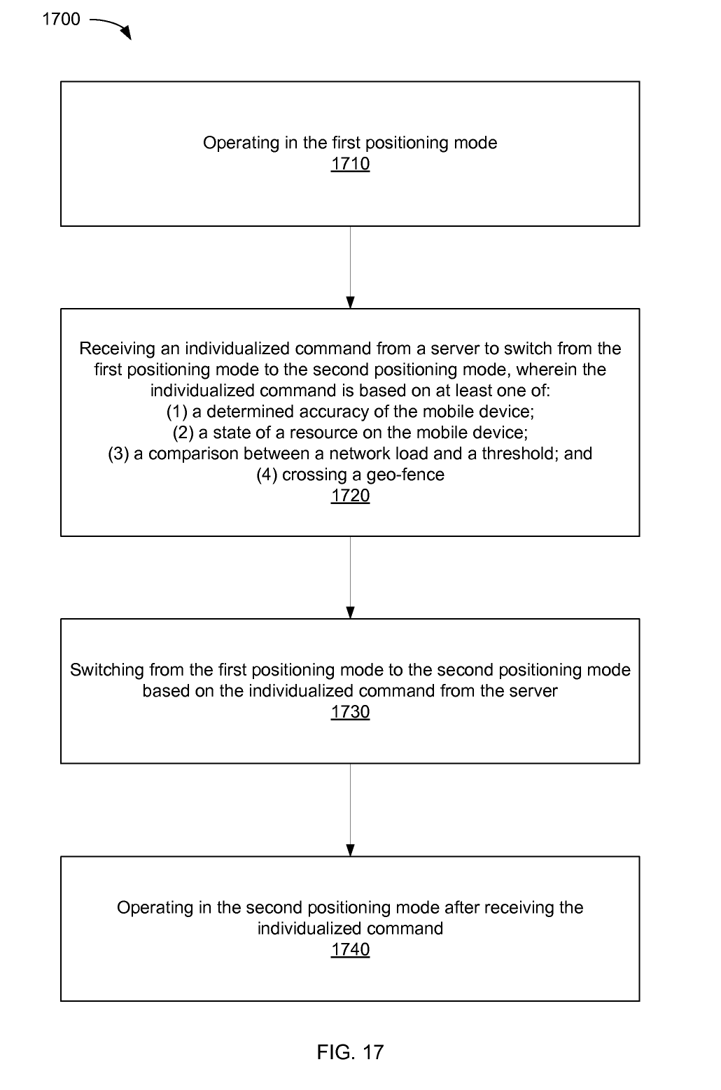

FIG. 17 illustrates a method 1700 in a mobile device 10 operating in a first positioning mode and a second positioning mode, in accordance with some embodiments. The first positioning mode and the second positioning mode comprise a mobile-based positioning mode for the mobile device 10 to perform position estimation and a network-based positioning mode for a network to perform position estimation. For example, the first positioning mode is a mobile-based positioning mode and the second positioning mode is a network-based positioning mode, or alternatively, the first positioning mode is a network-based positioning mode and the second positioning mode is a mobile-based positioning mode.

At 1710, the mobile device 10 operates in the first positioning mode.

At 1720, the mobile device 10 receives an individualized command from a server to switch from the first positioning mode to the second positioning mode. The individualized command is directed at only one mobile device 10 or is directed at a subset of mobile devices 10 but not all connected mobile devices 10 in the network's coverage area. The individualized command is based on at least one of: (1) a determined accuracy of the mobile device; and/or (2) a state of a resource; and/or (3) a comparison between a network load and a threshold; (4) a geo-fence; or (5) a combination thereof.

At 1730, the mobile device 10 switches from the first positioning mode to the second positioning mode based on the individualized command from the server.

At 1740, the mobile device 10 operates in the second positioning mode after receiving the individualized command.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A mobile device comprising:
a transceiver configured to receive an individualized command from a server to switch from a first positioning mode to a second positioning mode, wherein the first positioning mode is different from the second positioning mode; and
a processor coupled to the transceiver, wherein the processor is configured to:
operate in the first positioning mode before receiving the individualized command;
switch from the first positioning mode to the second positioning mode based on the individualized command from the server, wherein the individualized command is based on at least one of:
a determined accuracy of the mobile device;
a state of a resource;
a comparison between a network load and a threshold;
a geo-fence; or
a combination thereof; and
operate in the second positioning mode after receiving the individualized command.

2. The mobile device of claim 1, wherein the individualized command is based on the determined accuracy being an improved accuracy of the second positioning mode over the first positioning mode.

3. The mobile device of claim 1, wherein the individualized command is based on the state of the resource and the resource is sufficient within the mobile device.

4. The mobile device of claim 1, wherein the individualized command is based on the state of the resource and the resource is sufficient within a network.

5. The mobile device of claim 1, wherein the individualized command is based on the geo-fence.

6. The mobile device of claim 1, wherein the first positioning mode comprises a network-based positioning mode for a network to perform position estimation, and the second positioning mode comprises a mobile-based positioning mode for the mobile device to perform position estimation.

7. The mobile device of claim 1, wherein the first positioning mode comprises a mobile-based positioning mode for the mobile device to perform position estimation, and the second positioning mode comprises a network-based positioning mode for a network to perform position estimation.

8. A method in a mobile device, the method comprising:
operating in a first positioning mode;
receiving an individualized command from a server to switch from the first positioning mode to a second positioning mode, wherein the first positioning mode is different from the second positioning mode, and wherein the individualized command is based on at least one of:
a determined accuracy of the mobile device;
a state of a resource;
a comparison between a network load and a threshold; and
a geo-fence; or
a combination thereof; and
switching from the first positioning mode to the second positioning mode based on the individualized command from the server; and
operating in the second positioning mode after receiving the individualized command.

9. The method of claim 8, wherein the individualized command is based on the determined accuracy being an improved accuracy of the second positioning mode over the first positioning mode.

10. The method of claim 8, wherein the individualized command is based on the state of the resource and the resource is sufficient within the mobile device.

11. The method of claim 8, wherein the individualized command is based on the state of the resource and the resource is sufficient within a network.

12. The method of claim 8, wherein the individualized command is based on the geo-fence.

13. The method of claim 8, wherein the first positioning mode comprises a network-based positioning mode for a network to perform position estimation, and the second positioning mode comprises a mobile-based positioning mode for the mobile device to perform position estimation.

14. The method of claim 8, wherein the first positioning mode comprises a mobile-based positioning mode for the mobile device to perform position estimation, and the second positioning mode comprises a network-based positioning mode for a network to perform position estimation.

15. An apparatus comprising:
means for operating in a first positioning mode;
means for receiving an individualized command from a server to switch from the first positioning mode to a second positioning mode, wherein the first positioning mode is different from the second positioning mode, and wherein the individualized command is based on at least one of:
a determined accuracy of a mobile device;
a state of a resource;
a comparison between a network load and a threshold; and
a geo-fence; or
a combination thereof; and
means for switching from the first positioning mode to the second positioning mode based on the individualized command from the server; and
means for operating in the second positioning mode after receiving the individualized command.

16. The apparatus of claim 15, wherein the first positioning mode comprises a network-based positioning mode for a network to perform position estimation, and the second positioning mode comprises a mobile-based positioning mode for the mobile device to perform position estimation.

17. The apparatus of claim 15, wherein the first positioning mode comprises a mobile-based positioning mode for the mobile device to perform position estimation, and the second positioning mode comprises a network-based positioning mode for a network to perform position estimation.

18. The apparatus of claim 15, wherein the individualized command is based on the state of the resource and the resource is sufficient within the mobile device.

19. The apparatus of claim 15, wherein the individualized command is based on the state of the resource and the resource is sufficient within a network.
